(19) United States
(12) Patent Application Publication
(10) Pub. No.: US 2014/0209213 A1
(43) Pub. Date: Jul. 31, 2014

(54) CUTTING TOOL CONTROL BASED ON LOG POSITION

(71) Applicant: U. S. NATURAL RESOURCES, INC., Woodland, WA (US)

(72) Inventors: Stephen Doiel, Vancouver, WA (US); Brad Birlew, Parksville (CA); Stephan Meinke, Parksville (CA); Brian Walts, Parksville (CA)

(73) Assignee: U. S. Natural Resources, Inc., Woodland, WA (US)

(21) Appl. No.: 13/842,214

(22) Filed: Mar. 15, 2013

Related U.S. Application Data
(60) Provisional application No. 61/758,740, filed on Jan. 30, 2013.

(51) Int. Cl. B27B 1/00; B27B 31/06; B27B 31/00

(52) U.S. Cl. CPC B27B 1/007; B27B 31/006; B27B 31/06
USPC 144/356; 144/392; 144/397

(57) ABSTRACT

Embodiments of techniques and systems for control of cutting tools for logs on a conveyor are described herein. A preferred position may be determined for a log on a conveyor, such as, for example a chain conveyor. The preferred position may be determined based on a scan of the log prior to the log being placed on the conveyor. After the log is placed on the conveyor an initial portion of the log may be scanned by a second scan and the initial portion may be compared to a corresponding portion of the preferred position for the log. Differences may be determined between the scanned portion and the corresponding portion of the preferred position. One or more cutting tools may then be controlled, such as in position and/or orientation, to adjust for the determined differences. Other embodiments are also described and claimed.

### BACKGROUND

A wood workpiece, such as a log or a cant, is typically positioned during transport to control performance and/or output by subsequent sawing machines during breakdown of the workpiece. Thus, in many systems, a workpiece may be scanned to determine shape, position and/or orientation information for the workpiece. This information may then be utilized by an optimizer to determine a preferred position of the log during transport. Scanners and optimizers may also control a rotating conveyor or a log turner to rotate the log into such a preferred position on a conveyor for subsequent cutting. In various systems, the log may be transported on a sharp chain conveyor system. Such a sharp chain conveyor system may include a conveyor chain having sharp teeth which extend vertically upwards from the conveyor chain to firmly engage and secure onto the surface of the log.

However, although such systems may attempt to position the log in a preferred position, some systems may be limited in their ability to position the log into any arbitrary position. Further, after positioning, the log may be subsequently displaced from the preferred position during transport. This may cause the log to be placed in a position that is less than desirable, especially when compared to the original preferred position identified by the optimizer.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIGS. 1a and 1b are views of components included in and associated with embodiments of a tool control system, in accordance with various embodiments.

FIG. 2 illustrates an example control process of a tool control system, in accordance with various embodiments.

FIG. 3 illustrates an example preferred position determination process, in accordance with various embodiments.

FIG. 4 illustrates an example position difference determination process, in accordance with various embodiments.

FIG. 5 illustrates an example tool position control process, in accordance with various embodiments.

FIG. 6 illustrates an example computing environment suitable for practicing the disclosed embodiments, in accordance with various embodiments.

### DETAILED DESCRIPTION

Embodiments of techniques and systems for control of cutting and/or positioning tools for logs on a conveyor are described herein. In various embodiments, a log position optimizer may be configured to determine a preferred position for a log on a conveyor, such as, for example a chain conveyor. In various embodiments the log position optimizer may be configured to determine the preferred position based on a scan of the log prior to the log being placed on the conveyor. The log may then be turned or otherwise moved for placement on the conveyor according to the preferred position. After the log is placed on the conveyor, in various embodiments, an initial portion of the log may be scanned by a second scan and the initial portion may be compared to a corresponding portion of the preferred position for the log. Differences may be determined between the scanned portion and the corresponding portion of the preferred position. One or more cutting and/or positioning tools may then be controlled, such as in position and/or orientation, to adjust for the determined differences. In various embodiments, by scanning a portion of the log and controlling the cutting tools based on differences learned from the scan, errors in placement of the log on the conveyor may be reduced in a relatively quick and efficient manner. In some embodiments, one or more guides/positioning tools may be controlled based at least in part on the scan.

In the following detailed description, reference is made to the accompanying drawings which form a part hereof wherein like numerals designate like parts throughout, and in which is shown by way of illustration embodiments that may be practiced. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

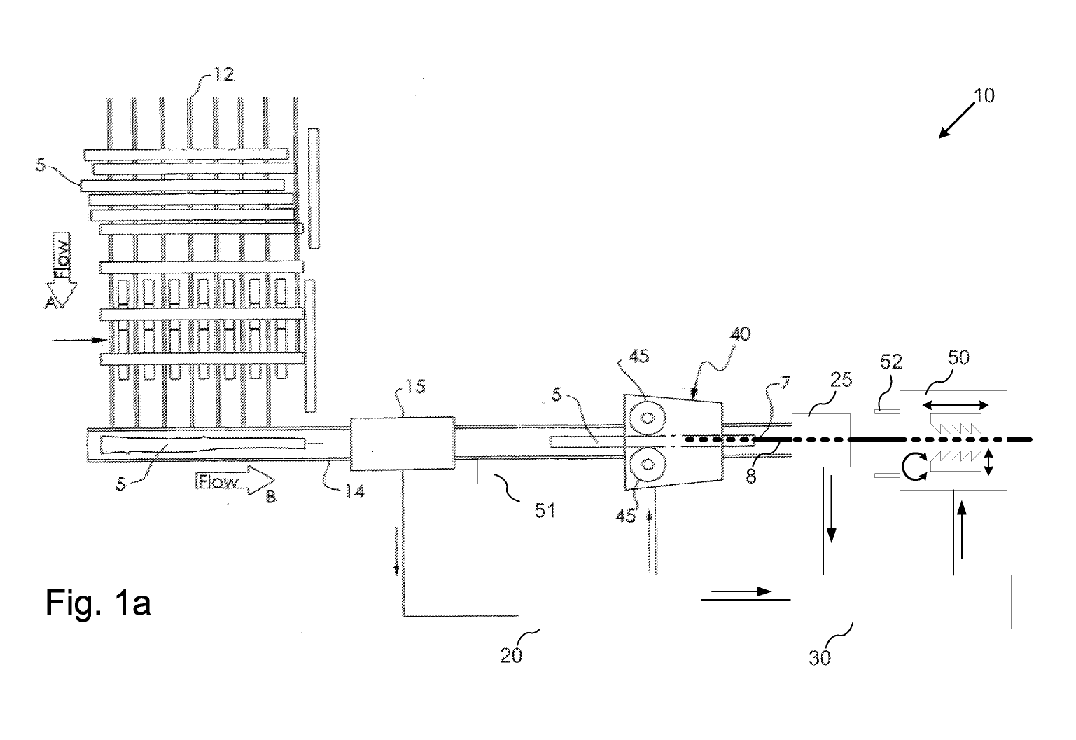

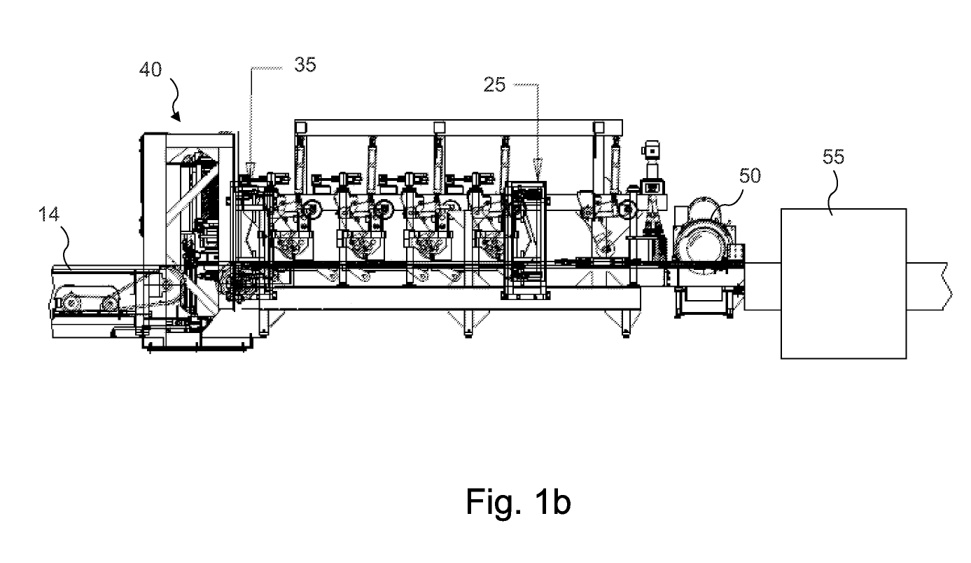

Referring now to FIGS. 1a and 1b, embodiments of a tool control system 10 (“system 10”) are illustrated. In various embodiments, the system 10 may include one or more of: a conveyer 14, first and second scanners 15 and 25, a log position optimizer 20 (“LPO 20”), a tool control optimizer 30 (“TCO 30”), a log turning mechanism 40 and cutting tools 50. Optionally, in some embodiments system 10 may further include a third scanner 35, a positioner 51 operatively coupled to conveyor 14 and/or chain conveyor 8, and/or a second cutting tool 50 (FIG. 1b). In various embodiments, cutting tool 50 may include, or may be operatively coupled to, one or more cutting tool positioners 52.

As seen in FIG. 1a, a plurality of logs 5, located on an infeed 12, may be transported by suitable means, such as a chainway or other conveyor, in downstream direction of flow A on a feedpath towards a conveyor 14. Logs 5 may then be transported on conveyor 14 in a downstream direction B toward and through a first scanner 15, entering the first scanner at a front end 7 of the log. First scanner 15 may detect geometrical information and/or surface characteristics or other features of each log 5. In some examples, first scanner 15 may be, or may include, a 3D scanner. Based on this scanned information, the LPO 20 may determine an optimized position for a log 5 such that the log 5 may be rotated, slewed, skewed, or otherwise moved into the optimized position prior to processing in downstream cutting tools 50. In various embodiments, the downstream cutting tools 50 may include tools such as, for example, a chip head, a saw, a canter, a gangsaw, etc. For example, as shown in FIG. 1b, cutting tools 50 may include one or more chip heads. Cutting tools 50 may independently include one or more chip heads, a saw, a canter, a gangsaw, or other type of cutting device. In some embodiments, cutting tools 50 may include, or may be operatively coupled to, one or more cutting tool positioners 52. Cutting tool positioners 52 may be saw guides, positioning rolls, or any other type of member or mechanism used to position the cutting tool (e.g., a movable saw box or saw carriage), a portion of the cutting tool (e.g., saw guides, saw arbor, etc.), or an incoming log (e.g., positioning rolls, a cutting tool infeed guide, etc.).

In various embodiments, the LPO 20 may be configured to control a log positioning mechanism 40 to rotate and position a log 5 into the optimized position determined by the LPO 20. In various embodiments, the log turning mechanism 40 may include a plurality of turning rolls 45 located on each side of conveyor 14 that may be spiked to enable turning rolls 45 to engage the surface of a log 5 to rotate and/or position the log 5. As seen in FIG. 1, while only two pairs of turning rolls 45 are illustrated, this illustration is not intended to be limited to two turning rolls 45, one on each side of conveyor 14. In other embodiments, two, three, four or more pairs of turning rolls 45 may be employed. In various embodiments, the log turning mechanism 40 may be used to rotate, slew, skew, and/or otherwise position the log 5 before the log is placed on a chain conveyor 8, such as a sharp chain, for further transport. In other embodiments, the log 5 may be placed on a conveyor other than a chain conveyor after positioning by the log turning mechanism 40.

In various embodiments, the log turning mechanism 40 may include or substitute other devices as part of a collective positioning mechanism. For example, the system 10 may include additional rolls, skids, or other devices downstream that may be used to skew and/or slew the log 5 after rotation and before the log is attached to the chain conveyor 8 and may include other turner types, such as, for example, knuckle turner infeeds, quad roll turners, ring turners etc. Optionally, the turning rolls 45 and/or other components of the log turning mechanism 40 may be configured to skew and/or slew the log 5 before the log is placed onto the chain conveyor 8. For example, conveyor 14 and/or chain conveyor 8 may be operatively coupled to a conveyor positioner 51 that is configured to skew, slew, tilt, or otherwise adjust the conveyor 14 and/or chain conveyor 8. In some embodiments, the position of log 5 may be adjusted in this manner before the log 5 enters the cutting tools 50.

The log may be placed onto the chain conveyor in an initial position. This initial position may be the optimized position or another position (e.g., a position that deviates from the optimized position).

In various embodiments, the system 10 may also include a second scanner 25 positioned along the chain conveyor 8 downstream of the log positioning mechanism 40 and upstream of the cutting tools 50. Similarly to the first scanner 15, the second scanner 25 may detect geometrical information and/or surface characteristics or features of each log 5. In some embodiments, the second scanner 25 may be positioned proximal to the cutting tools 50. For example, the second scanner 25 may be nearer to the cutting tools 50 than to the log rotator 40. In a specific example, the distance between the second scanner 25 and the log may be about 10-18 feet. The second scanner 25 may be configured to detect geometrical information and/or surface characteristics or features of a portion of the log 5. Optionally, the portion of the log scanned by the second scanner 25 may be less than the entire length of the log 5. For example, the second scanner 25 may scan a leading end of the log 5.

Optionally, in some embodiments a third scanner 35 may be positioned proximal to the log rotator 40. Third scanner 35 may monitor the position of the log 5 as the log 5 is being rotated and/or as the log 5 is being placed onto the chain conveyor 8 in the initial position. As with the second scanner 25, the third scanner 35 may scan a portion of the log 5 rather than the entire log 5 in order to reduce scanning time. The use of a reduced scanning time may allow faster throughput of logs.

In various embodiments, the geometrical information and/or surface characteristics or features of the portion of the log 5 may be used by the TCO 30 to determine the actual position of the log 5. The TCO may use the scan data from one or more of the scanners to determine whether the log 5 is in the optimized position and/or whether the log 5 has changed positions since it was placed on the chain conveyor 8. For example, the TCO 30 may compare the initial position of the log (e.g., determined based on log position data from the third scanner 35) to a current position of the log (e.g., determined based on log position data from the second scanner 25). Alternatively, TCO 30 may use the geometrical information and/or surface characteristics or features of the portion of the log 5 to determine whether the log is in the optimized position determined by the LPO 20. This may involve, for example, comparing the optimized position determined by the LPO 20 to the actual position determined by the TCO 30.

In various embodiments, the second scanner 25 may be coupled to the TCO 30 to provide the detected geometrical information and/or surface characteristics or features of each log 5 to the TCO 30. In some embodiments, the TCO 30 may also be coupled to the LPO 20 to receive an optimized position and/or scan data for each log 5 from the LPO 20. In other embodiments, based on the scanned information from the CCS 25 and the preferred position information from the LPO 20, the TCO 30 may control one or more cutting tools 50 that may be configured to cut the log 5 after placement on the chain conveyor 8. In some embodiments, the TCO 30 may control the one or more cutting tools 50 based on differences determined between the optimized position for the log 5 and the actual position for the log 5 on the conveyor 8. Alternatively, the TCO 30 may control the one or more cutting tools 50 based on differences determined between the initial position of the log 5 on the conveyor 8 and the actual position of the log 5 on the conveyor 8. In various embodiments, as mentioned above, the optimized position for the log 5 may be provided to the TCO 30 by the LPO 20. In various embodiments, the actual position for the log 5 may be determined from information scanned by the CCS 25. Optionally, the initial position for the log 5 may be determined by either the LPO 20 or the TCO 30 based on scan data from the third scanner 35.

In various embodiments, based on the determination of differences between the actual position and preferred position of the log 5, or differences between the actual position and the optimized position, the TCO 30 may adjust or otherwise control position and/or orientation of the one or more cutting tools 50 to partially or fully offset the determined differences. In various embodiments, the one or more cutting tools 50 may be caused to be moved in one or more directions in three-dimensional space based on control from the TCO 30. In other embodiments, the one or more cutting tools may be rotated about an axis. While FIG. 1a illustrates some examples of particular types/directions of cutting tool movements, this illustration is not intended to be limited to the types of movement that are illustrated. In other embodiments, the TCO 30 and cutting tools 50 may be configured to be adjusted in ways other than position and/or orientation, such as by changing cutting speed, depth, or other parameters. In addition, where the cutting tools 50 include more than one cutting element (e.g., pairs of chip heads), the cutting elements may be moved individually or collectively to offset differences between desired log position and actual log position.

In some embodiments, based at least on the determination of differences between the actual position and preferred position of the log 5, or differences between the actual position and the optimized position, the TCO 30 may adjust or otherwise control position and/or orientation of one or more other tools (e.g., conveyor positioner 51 and/or cutting tool positioner 52) to partially or fully offset the determined differences. For example, in some embodiments, TCO 30 may control the conveyor positioner 51 to raise, lower, tilt, skew, and/or otherwise adjust the position, speed, and/or orientation of conveyor 14 and/or chain conveyor 8 to offset the determined differences. In other embodiments, cutting tools 50 may include, or may be operatively coupled to, one or more cutting tool positioners 52. The TCO 30 may control the cutting tool positioner 52 to adjust the position of cutting tool 50 or some portion thereof (e.g., a saw blade, saw guide, saw arbor, saw box, etc.), or to adjust the position of a log that is proceeding into the cutting tool 50.

In various embodiments, while the LPO 20 and TCO 30 are referred to herein as a log position “optimizer” and a tool control “optimizer,” respectively, it may be understood that this does not place any particular limitation or requirement on any results or determination made by the LPO 20 and/or the TCO 30. Instead, log positions and/or orientations may be determined, and/or tools (e.g., cutting tools and/or positioning tools) controlled, without requiring any particular position, orientation, or control to be determined to be “optimal.” Further, while in the illustrated embodiments, the LPO 20 and TCO 30 are illustrated as separate devices, it may be recognized that, in various embodiments, the LPO 20 and TCO 30 may be components of a common computing device.

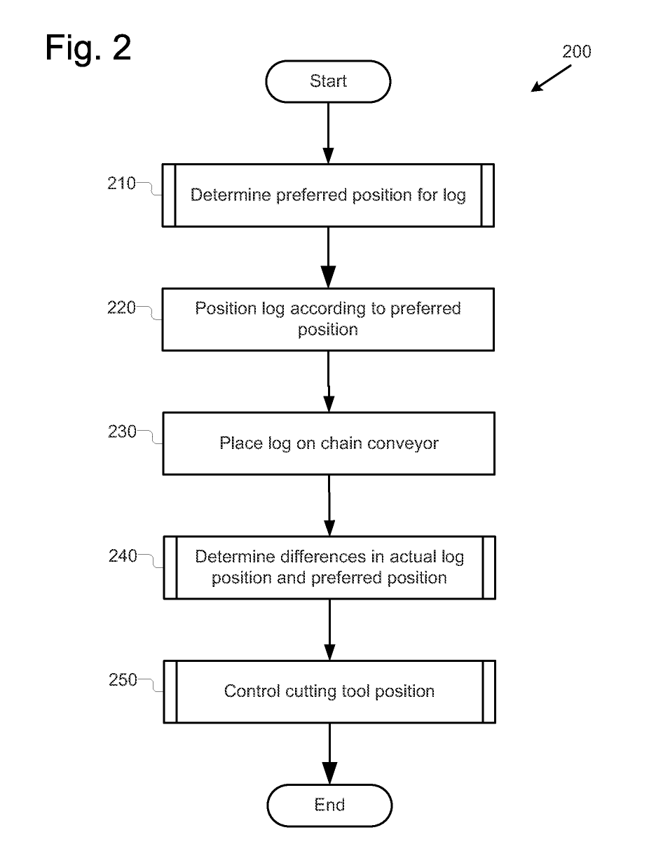

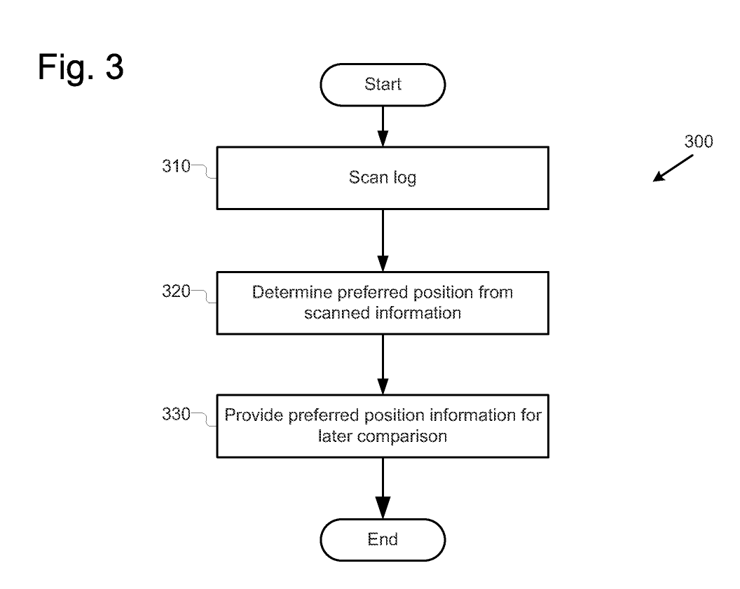

FIG. 2 illustrates an example tool control process 200 of the tool control system 10, in accordance with various embodiments. It may be recognized that, while the operations of process 200 are arranged in a particular order and illustrated once each, in various embodiments one or more of the operations may be repeated, omitted, or performed out of order. Although the operations of process 200 are discussed with reference to control of cutting tool position, it is to be recognized that process 200 or parts thereof may be used to control one or more other tools (e.g., conveyor positioner 51 and/or cutting tool positioner 52) instead of, or in addition to, cutting tool 50. The process may begin at operation 210, where, the system 10 may determine an optimized position for the log 5. In various embodiments, operation 210 may be performed by, among other components, the first scanner 15 and the LPO 20. Examples of embodiments of operation 210 are described below with reference to process 300 of FIG. 3.

Next, at operation 220, system 10 may position the log 5 according to the preferred position. In various embodiments, this operation may be performed by the log positioning mechanism 40. Next, at operation 230, in various embodiments, the log 5 may also be placed on the chain conveyor 8. In some embodiments, the log 5 may be placed on a different type of conveyor, as may be understood.

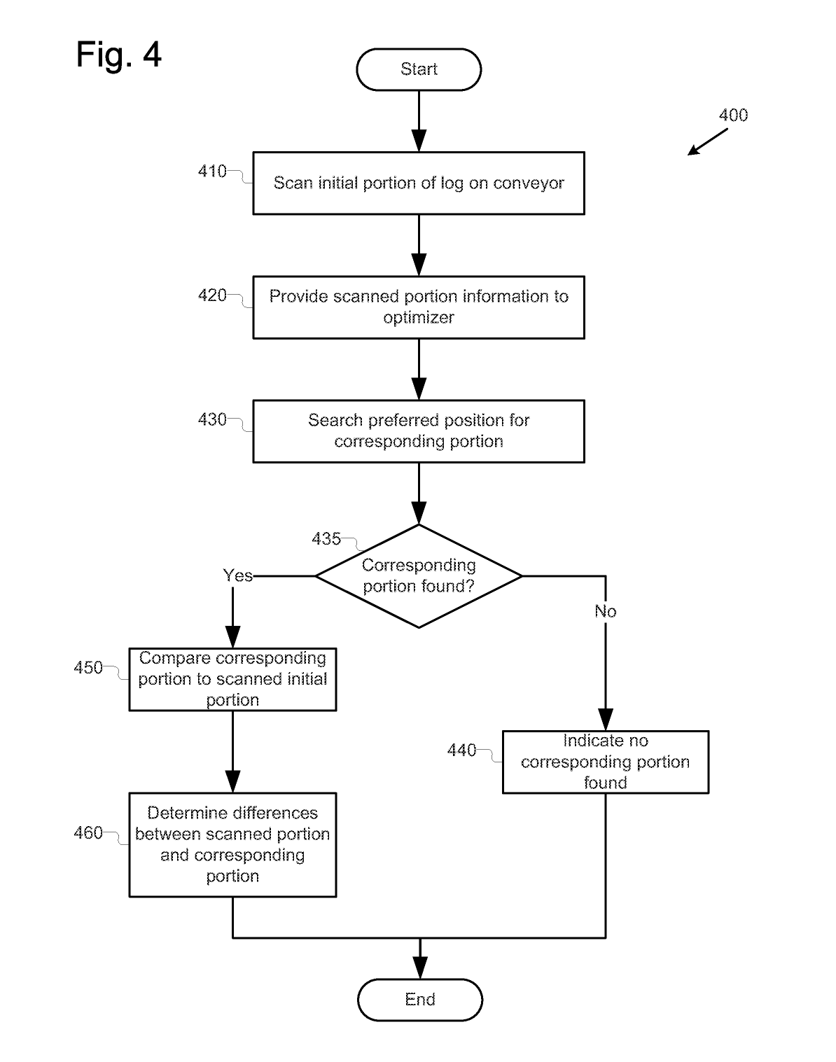

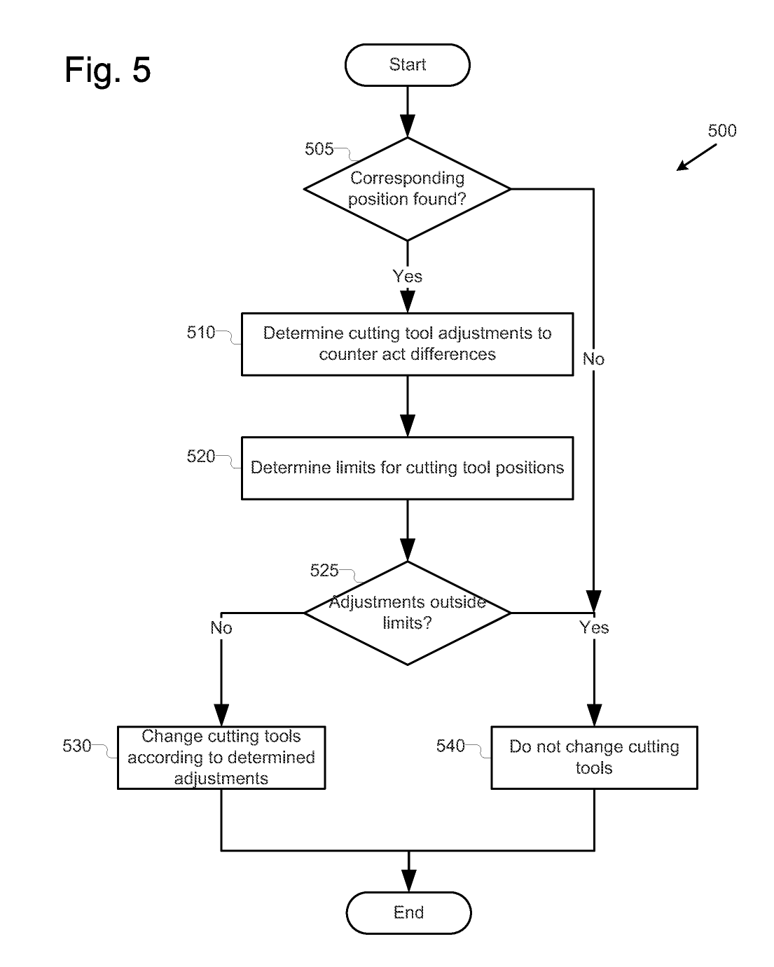

Next, at operation 240, the system 10 may determine differences between the actual log position of the log 5 on the chain conveyor 8 and the preferred position determined at operation 210. In various embodiments, operation 240 may be performed by, among other components, the CCS 25 and the TCO 30. Examples of embodiments of operation 240 are described below with reference to process 400 of FIG. 4. Next, at operation 250, the system 10 may control the position and/or orientation of one or more of the cutting tools 50. In various embodiments, operation 250 may be performed by, among other components, the TCO 30. Examples of embodiments of operation 250 are described below with reference to process 400 of FIG. 5. The process may then end.

FIG. 3 illustrates an example preferred position determination process 300, in accordance with various embodiments. In various embodiments, operation 300 may include one or more implementations of operation 210 of process 200. It may be recognized that, while the operations of process 300 are arranged in a particular order and illustrated once each, in various embodiments one or more of the operations may be repeated, omitted, or performed out of order.

The process may begin at operation 310, where the first scanner 15 may scan the log, such as to detect geometrical information and/or surface characteristics or features of each log 5. In various embodiments, at operation 310 the first scanner 15 may scan all or a portion of the log 5. In various embodiments, the first scanner 15 may, at operation 310, scan a portion of the log that corresponds to a portion of the log to be later scanned by the second scanner 25 and/or the third scanner 35.

Next, at operation 320, the LPO 20 may determine an optimized position for the log 5 based on the scanned information from the first scanner 15. In various embodiments, the LPO 20 may make this determination based on aspects of the log 5 such as shape, size, orientation, and/or stability. Next, at operation 330, the LPO 20 may provide the determined optimized position information for later comparison. In various embodiments, the LPO 20 may provide the optimized position information directly to the TCO 30. The process may then end. Optionally, in embodiments that include the third scanner 35 may scan the log 5 during and/or immediately after rotation of the log 5. The LPO 20 may use the scan data from the third scanner 35 to determine an initial position of the log 5 on the chain conveyor 8. In some embodiments, the LPO 20 may also determine a difference between the optimized position and the initial position.

FIG. 4 illustrates an example position difference determination process 400, in accordance with various embodiments. In various embodiments, operation 400 may include one or more implementations of operation 240 of process 200. It may be recognized that, while the operations of process 400 are arranged in a particular order and illustrated once each, in various embodiments one or more of the operations may be repeated, omitted, or performed out of order.

The process may begin at operation 410, where the second scanner 25 may scan an initial portion of the log 5. In some embodiments, the second scanner 25 may be configured, at operation 410, to scan a different portion of the log 5 other than an initial portion, or may scan the entire log 5. In various embodiments, the second scanner 25 may, at operation 410, scan a set length of the log 5, such as, for example, an initial two feet of the log 5. Next, at operation 420, the second scanner 25 may provide the information from the scan of the portion to the TCO 30.

Next, at operation 430, the TCO 30 may process the optimized/initial position information for the log 5 to determine a portion of the optimized/initial position that corresponds to the information from the portion scanned at operation 410. Then, at decision operation 435, the TCO 30 may determine if the corresponding portion was found. If not, then at operation 440, the TCO 30 may indicate that no corresponding portion of the optimized/initial position was found, and the process may end.

However, if, at decision operation 435, the TCO 30 determines that a corresponding portion of the optimized/initial position was found, then at operation 450, the TCO 30 may compare the corresponding portion of the optimized/initial position to the scanned initial portion. Then, at operation 460, the TCO 30 may determine one or more differences between the portion of the optimized/initial position and the scanned portion. The process may then end.

FIG. 5 illustrates an example cutting tool position control process 500, in accordance with various embodiments. In various embodiments, operation 500 may include one or more implementations of operation 250 of process 200. It may be recognized that, while the operations of process 500 are arranged in a particular order and illustrated once each, in various embodiments one or more of the operations may be repeated, omitted, or performed out of order.

The process may begin at decision operation 505, where the TCO 30 may determine if a corresponding portion was found, such as at operation 430 of process 400. If no corresponding position was found, then the TCO 30 may proceed to operation 540. In some embodiments, at operation 540 any adjustment to cutting tool(s) 50 may be clamped or otherwise limited to the limit of the cutting tools 50. In other embodiments, at operation 540 CTO 30 may perform no changes to the one or more cutting tools 50. Optionally, the TCO 30 may determine that there are no differences between the optimized/initial position and the actual position, or that any such differences are within a predetermined margin of acceptable deviation/error. In that event, the TCO 30 may proceed to operation 540.

Next, at operation 510, the TCO 30 may determine one or more cutting tool adjustments to the one or more cutting tools 50 that may counter act the differences determined during process 400. In various embodiments, as described above, the adjustments determined at operation 510 may include changes in position, orientation, and/or angle of the one or more cutting tools 50. In some embodiments, the adjustments determined at operation 510 may include adjustments to fewer than all of the one or more cutting tools 50.

Next, at operation 520, the TCO 30 may determine whether these adjustments are within operating limits of the one or more cutting tools 50. Next, at operation 525, the TCO may perform different operations depending on whether the adjustments were outside limits of the cutting tools. If the adjustments were outside of the limits of the one or more cutting tools 50, then the TCO 30 may proceed to operation 540. The process may then end. If, however, one or more of the adjustments are within the limits of the one or more cutting tools 50, then at operation 530, the cutting tools may be repositioned/controlled by the TCO according to the determined adjustments. In various embodiments, the changes performed in operation 530 may be made to fewer than all of the one or more cutting tools 50. In particular, if some adjustments determined at operation 510 are outside of the limits of particular cutting tools, while other adjustments are not outside of limits, then the TCO 30 may, at operation 530, only change those cutting tools/parameters that may be adjusted within limits. In other embodiments, if the determined adjustments are outside of the limits for the cutting tools, one or more of the cutting tools may be adjusted up to their particular limits, rather than performing no adjustments to those cutting tools. The process may then end.

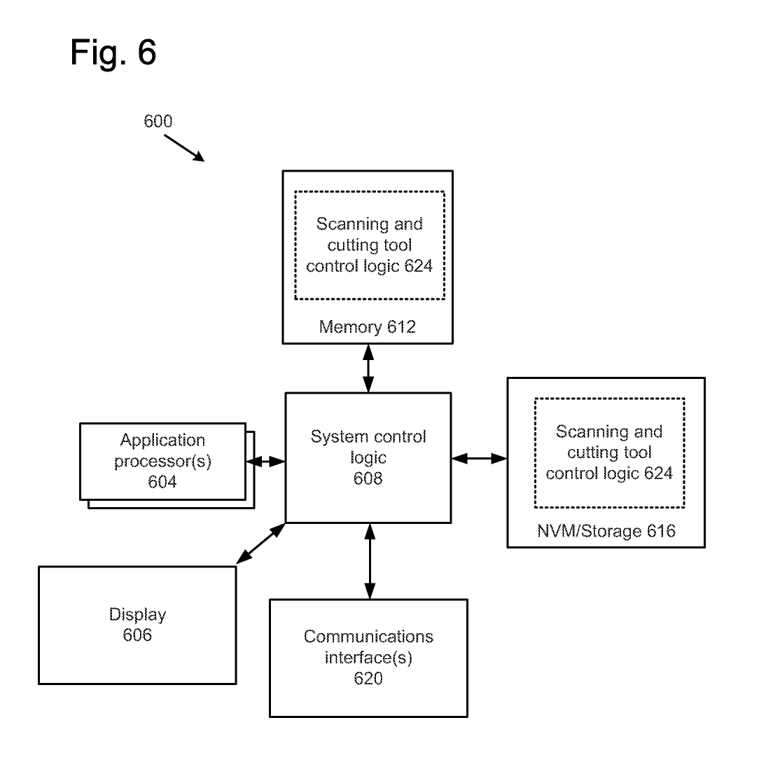

FIG. 6 illustrates, for one embodiment, an example computing device 600 suitable for practicing embodiments of the present disclosure. As illustrated, example computing device 600 may include control logic 608 coupled to at least one of the processor(s) 604, system memory 612 coupled to system control logic 608, non-volatile memory (NVM)/storage 616 coupled to system control logic 608, and one or more communications interface(s) 620 coupled to system control logic 608. In various embodiments the one or more processors 604 may be a processor core.

System control logic 608 for one embodiment may include any suitable interface controller(s) to provide for any suitable interface to at least one of the processor(s) 604 and/or to any suitable device or component in communication with system control logic 608. System control logic 608 may also interoperate with a display 606 for display of information, such as to a user. In various embodiments the display may include one of various display formats and forms, such as, for example, liquid-crystal displays, cathode-ray tube displays, and e-ink displays. In various embodiments the display may include a touch screen.

System control logic 608 for one embodiment may include one or more memory controller(s) to provide an interface to system memory 612. System memory 612 may be used to load and store data and/or instructions, for example, for system 600. In one embodiment system memory 612 may include any suitable volatile memory, such as suitable dynamic random access memory (“DRAM”).

System control logic 608, in one embodiment, may include one or more input/output (“I/O”) controller(s) to provide an interface to NVM/storage 616 and communications interface(s) 620.

NVM/storage 616 may be used to store data and/or instructions, for example. NVM/storage 616 may include any suitable non-volatile memory, such as flash memory, for example, and/or may include any suitable non-volatile storage device(s), such as one or more hard disk drive(s) (“HDD(s)”), one or more solid-state drive(s), one or more compact disc (“CD”) drive(s), and/or one or more digital versatile disc (“DVD”) drive(s), for example.

The NVM/storage 616 may include a storage resource that may physically be a part of a device on which the system 600 is installed, or it may be accessible by, but not necessarily a part of, the device. For example, the NVM/storage 616 may be accessed over a network via the communications interface(s) 620.

System memory 612, NVM/storage 616, and system control logic 608 may include, in particular, temporal and persistent copies of scanning and cutting tool control logic 624. The scanning and cutting tool control logic 624 may include instructions that when executed by at least one of the processor(s) 604 result in the system 600 practicing one or more aspects of the techniques described above. Communications interface(s) 620 may provide an interface for system 600 to communicate over one or more network(s) and/or with any other suitable device. Communications interface(s) 620 may include any suitable hardware and/or firmware, such as a network adapter, one or more antennas, a wireless interface, and so forth. In various embodiments, communication interface(s) 620 may include an interface for system 600 to use NFC, optical communications (e.g., barcodes), BlueTooth or other similar technologies to communicate directly (e.g., without an intermediary) with another device. In various embodiments, the wireless interface may interoperate with radio communications technologies such as, for example, WCDMA, GSM, LTE, and the like.

The capabilities and/or performance characteristics of processors 604, memory 612, and so forth may vary. In various embodiments, computing device 600 may be, but not limited to, a smartphone, a computing tablet, an ultrabook, an e-reader, a laptop computer, a desktop computer, a set-top box, a game console, or a server. In various embodiments computing device 600 may be, but not limited to, one or more servers known in the art.

For one embodiment, at least one of the processor(s) 604 may be packaged together with system control logic 608 and/or scanning and cutting tool control logic 624. For one embodiment, at least one of the processor(s) 604 may be packaged together with system control logic 608 and/or scanning and cutting tool control logic 624 to form a System in Package (“SiP”). For one embodiment, at least one of the processor(s) 604 may be integrated on the same die with system control logic 608 and/or scanning and cutting tool control logic 624. For one embodiment, at least one of the processor(s) 604 may be integrated on the same die with system control logic 608 and/or scanning and cutting tool control logic 624 to form a System on Chip (“SoC”).

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. A system comprising:
a conveyor configured to convey a log;
a first scanner/optimizer configured to:
scan the log; and
determine an optimized position for the log on the conveyor;
one or more log positioning mechanisms configured to controllably rotate and/or position the log for placement of the log on the conveyor; and
a second scanner/optimizer configured to:
scan a portion of the log after the log is placed on the conveyor;
determine an actual position of the log on the conveyor;
compare the scanned portion of the log to a corresponding portion of the optimized position for the log; and
control positions and/or orientations of one or more cutting tools or positioners positioned downstream of the second scanner/optimizer, the control being based at least in part on a result of the compare.

2. The system of claim 1, wherein the scanned portion of the log is less than the entire log.

3. The system of claim 1, wherein the scanned portion of the log is a portion starting at an initial edge of the log.

4. The system of claim 1, wherein compare the scanned portion of the log to the corresponding portion of the preferred position for the log comprises determine one or more differences between a current position of the scanned portion of the log and the corresponding portion of the preferred position for the log.

5. The system of claim 4, wherein control positions and/or orientations of one or more cutting tools comprises:
determine one or more position and/or orientation adjustments for the one or more cutting tools or positioners based on the one or more determined differences; and
change positions and/or orientations of the one or more cutting tools or positioners based on the adjustments.

6. The system of claim 4, wherein control positions and/or orientations of one or more cutting tools comprises:
determine that the one or more determined differences cannot be adjusted for through change of positions and/or orientations of the one or more cutting tools; and
perform no changes to positions and/or orientations of the one or more cutting tools.

7. The system of claim 6, wherein determine that the one or more determined differences cannot be adjusted for comprises determine that the one or more determined differences are outside of available adjustments that can be made to the one or more cutting tools.

8. The system of claim 1, wherein compare the scanned portion of the log to the corresponding portion of the preferred position for the log comprises perform a search over the preferred position for the log to attempt to identify a corresponding portion of the preferred position for the log that corresponds to the scanned portion of the log.

9. The system of claim 8, wherein, if a corresponding portion of the preferred position for the log is not identified, control positions and/or orientations of the one or more cutting tools comprises perform no changes to the positions and/or orientations of the one or more cutting tools.

10. The system of claim 1, wherein the conveyor comprises a chain conveyor.

11. The system of claim 10, wherein:
the chain conveyor is configured to impale the log at one or more points of the log; and
the second scanner/optimizer is configured to scan the portion of the log after the log has been impaled on the chain conveyor.

12. A method for controlling cutting of a log placed on a conveyor, the method comprising:
scanning, under control of a computing device, a portion of a log placed on a conveyor;
comparing, under control of the computing device, the scanned portion of the log with a corresponding portion of a preferred position for the log on the conveyor; and
controlling, under control of the computing device, positions and/or orientations of one or more cutting tools configured to cut the log, the controlling being based at least in part on a result of the compare

13. The method of claim 12, wherein:
the computing device comprises a first computing device; and
the method further comprises:
scanning, under control of a second computing device, the log to determine position, shape, and/or orientation information for the log; and
determining, under control of the second computing device, the preferred position of the log based at least in part on the information from the scanning.

14. The method of claim 12, wherein scanning the portion of the log comprises scanning an initial portion of the log starting at an initial edge of the log.

15. The method of claim 12, wherein comparing the scanned portion of the log with the corresponding portion of the preferred position for the log comprises determining one or more differences between a current position of the scanned portion of the log and the corresponding portion of the preferred position for the log.

16. The method of claim 15, wherein controlling positions and/or orientations of one or more cutting tools comprises:
determining one or more position and/or orientation adjustments for the one or more cutting tools based on the one or more determined differences; and
changing positions and/or orientations of the one or more cutting tools based on the adjustments.

17. The method of claim 15, wherein controlling positions and/or orientations of one or more cutting tools comprises:
determining that the one or more determined differences cannot be adjusted for by changing positions and/or orientations of the one or more cutting tools; and
performing no changes to positions and/or orientations of the one or more cutting tools.

18. The method of claim 17, wherein determining that the one or more determined differences cannot be adjusted for comprises determining that the one or more determined differences are outside of available adjustments that can be made to the one or more cutting tools.

19. The method of claim 12, wherein comparing the scanned portion of the log with the corresponding portion of the preferred position for the log comprises searching over the preferred position for the log to attempt to identify a corresponding portion of the preferred position for the log that corresponds to the scanned portion of the log.

20. The method of claim 19, wherein, if a corresponding portion of the preferred position for the log is not identified, controlling positions and/or orientations of the one or more cutting tools comprises performing no changes to the positions and/or orientations of the one or more cutting tools.

21. One or more computer-readable media comprising instructions stored thereon that are configured to cause a computing device, in response to execution of the instructions by the computing device, to:
compare a scanned portion of a log placed on a conveyor with a corresponding portion of a preferred position for the log on the conveyor; and
control positions and/or orientations of one or more cutting tools configured to cut the log based at least in part on a result of the compare

22. The computer-readable media of claim 21, wherein:
the instructions are further configured to cause the computing device to perform a scan of the portion of the log after placement on the conveyor;
the computing device comprises a first computing device; and
the preferred position of the log is determined under control of a second computing device that is configured to:
scan the log to determine position, shape, and/or orientation information for the log prior to placement on the conveyor; and
determine the preferred position of the log based at least in part on the information from the scanning

23. The computer-readable media of claim 21, wherein the instructions are configured to cause the computing device to scan the portion of the log through scan of an initial portion of the log starting at an initial edge of the log.

24. The computer-readable media of claim 21, wherein the instructions are configured to cause the computing device to compare the scanned portion of the log with the corresponding portion of the preferred position for the log through determination of one or more differences between a current position of the scanned portion of the log and the corresponding portion of the preferred position for the log.

25. The computer-readable media of claim 24, wherein the instructions are configured to cause the computing device to control positions and/or orientations of one or more cutting tools through:
determination of one or more position and/or orientation adjustments for the one or more cutting tools based on the one or more determined differences; and
change of positions and/or orientations of the one or more cutting tools based on the adjustments.

26. The computer-readable media of claim 24, wherein the instructions are configured to cause the computing device to control positions and/or orientations of one or more cutting tools through:
determination that the one or more determined differences cannot be adjusted for by changing positions and/or orientations of the one or more cutting tools; and
performance of no changes to positions and/or orientations of the one or more cutting tools.

27. The computer-readable media of claim 26, wherein determination that the one or more determined differences cannot be adjusted for comprises determination that the one or more determined differences are outside of available adjustments that can be made to the one or more cutting tools.

28. The computer-readable media of claim 21, wherein the instructions are configured to cause the computing device to compare the scanned portion of the log with the corresponding portion of the preferred position for the log through search over the preferred position for the log to attempt to identify a corresponding portion of the preferred position for the log that corresponds to the scanned portion of the log.

29. The computer-readable media of claim 28, wherein the instructions are configured to cause the computing device, if a corresponding portion of the preferred position for the log is not identified, to control positions and/or orientations of the one or more cutting tools through performance of no changes to the positions and/or orientations of the one or more cutting tools.
